(19) United States
(12) Patent Application Publication
(10) Pub. No.: US 2003/0206491 A1
(43) Pub. Date: Nov. 6, 2003

(54) Voice-activated lens shading

(76) Inventors: Arcilio S. Pacheco, San Jose, CA (US); Sarah E. Pacheco, San Jose, CA (US)

Correspondence Address: Arcilio S. Pacheco, 14288 Bercaw Lane, San Jose, CA, 95124, US

(21) Appl. No.: 10/139,714

(22) Filed: May 6, 2002

(51) Int. Cl. G10K 11/00

(52) U.S. Cl. 367/198

(57) ABSTRACT

A welding hood assembly which includes a voice-activated lens shade adjusting device. The welding hood is equipped with an electronically-controlled lens whose shade darkness can be immediately and incrementally adjusted via voice commands spoken into a microphone mounted inside the hood and integrated with a voice-command system. When the welder produces a voice command for a specific degree of shading, the lens will immediately change to the desired level of shade.

### BACKGROUND OF THE INVENTION

1. Field of Invention

This invention relates to welding hood lens shading devices, specifically to those whose shading can be electronically adjusted. This invention also relates to the technology of speech-recognition and voice-activation as it pertains to hands-free operation of electronic devices.

2. Description of Prior Art

When welding, it is critical for the welder to clearly see how the weld is progressing. Degree of shading of the welding hood lens can significantly impact the welder's ability to create a quality weld. If the lens is too light or dark, the welder cannot clearly see the weld. Frequently, during the course of a weld, especially in the field, lighting conditions can change enough that a welder would need to change lens shading. Even under the more controlled environment of a fabrication shop, a welder may be compelled to change welding hoods or lenses because different welding or cutting procedures produce different intensities of light.

Traditional welding hood lenses are made of glass or plastic, and have a set degree of shading. The lenses can be changed only by the welder's removing the hood and manually removing and replacing the lens to adjust to differing light. This action interrupts welding, lowers the welder's productivity, and can have a negative impact upon the weld's quality.

Electronic welding hood lenses which use liquid crystal light shutters and polarizers appeared in the 1970s. U.S. Pat. No. 3,873,804. This technology provided lenses which were clear in ambient light. Upon the striking of a welding arc, the photosensitive lens would automatically darken to a predetermined shade, adequate to protect the welder's eyes from the arc's light, yet not adjustable to the number of shades available in the traditional welding hood. Subsequent improvements in liquid crystal technology demonstrated in such U.S. Pat. Nos. 3,977,767, 4,039,254, and 4,240,709, improved electronic welding lenses.

More recently, welding hood/lens systems have emerged which provide the welder variable shading options in an electronic lens. These welding hoods use liquid crystal lens whose shade can be electronically set by manually turning a dial or pushing buttons mounted on the welding hood. Examples of this technology is shown in U.S. Pat. Nos. 5,959,705, and 6,070,264. This lens incorporates both the auto-darkening feature mentioned above with the ability to preset the lens to the desired shade. Although these manual adjustments are simpler than physically replacing lenses, they still require the welder to interrupt his work to adjust the lens shade.

Concurrently to the developments cited above, technology in the area of speech-recognition and voice-activation devices have improved significantly over the last quarter-century. Such devices allow hands-free operation of electromechanical devices. Examples of successful application of the technology can be seen in U.S. Pat. Nos. 4,462,080, 4,641,292, 5,345,538 and 5,832,440. Several manufacturers now produce small, inexpensive, and accurate speech-recognition/voice-activation integrated circuit devices.

### SUMMARY OF THE INVENTION

The objects and advantages of the present invention are:

to provide a welding hood/lens assembly which uses voice commands to adjust lens shades/settings, thus allowing welder to adjust, hands-free, lens shading during the welding process, which

a) by allowing welder to adjust lens shading during welding, welder will be better able to see the welding process and produce a better weld.

b) by allowing the welder to adjust lens shading by voice rather than by manual means, the welder will be able to produce a weld of better integrity, with fewer starts and stops.

c) by allowing the welder to make lens shade adjustments via voice commands, thus eliminating the need to remove the welding hood, adjust controls, change lenses, or change welding hoods or face shields, welder can be more productive.

### DRAWING FIGURES

FIG. 1 shows the exterior of the welding hood.

FIG. 2 shows the interior of the welding hood.

FIG. 3 shows chart of voice-activation command set and default settings for welding hood assembly.

### DESCRIPTION OF DRAWINGS

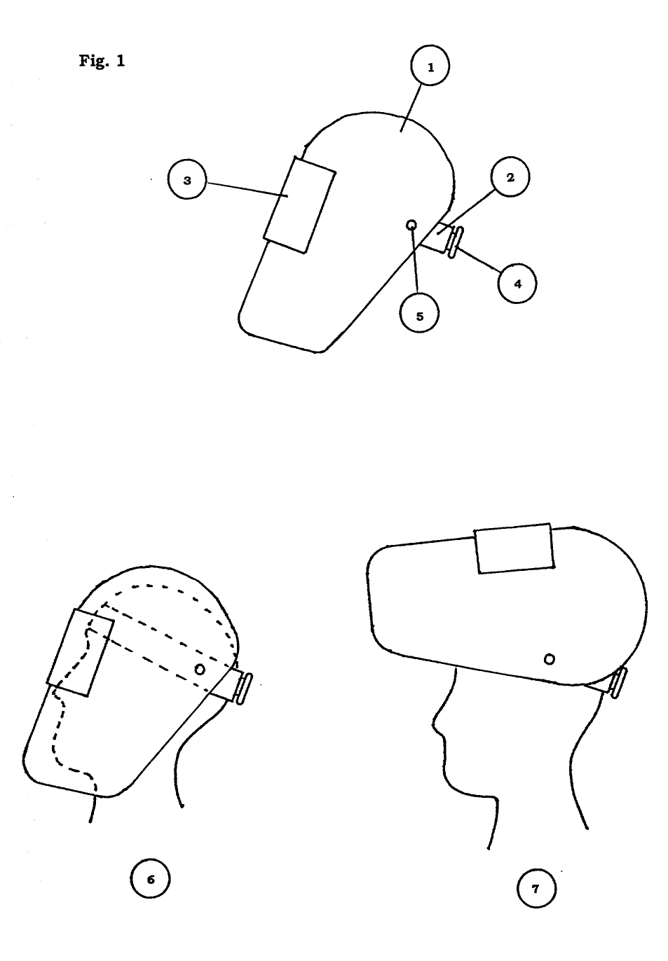

A typical embodiment of the welding hood with voice-activated shutter control is illustrated in FIG. 1. The welding hood 1 consists of a non-conductive, non-combustible material such as plastics or fiber board. Its configuration provides adequate protection from sparks, and is free of light leaks. The welding hood harness 2 allows the welding hood to be positioned upon the welder's head securely and comfortably, while allowing adjustments, using adjustment knob 4 to attain the size of said welder's head. The welding hood lens 3 can be of a size which allows the welder a range of vision adequate to perform the welding, cutting or grinding activity with ease. The welding hood hinge 5 gives the welder the option of wearing hood in the welding position 6 or the at-rest position 7.

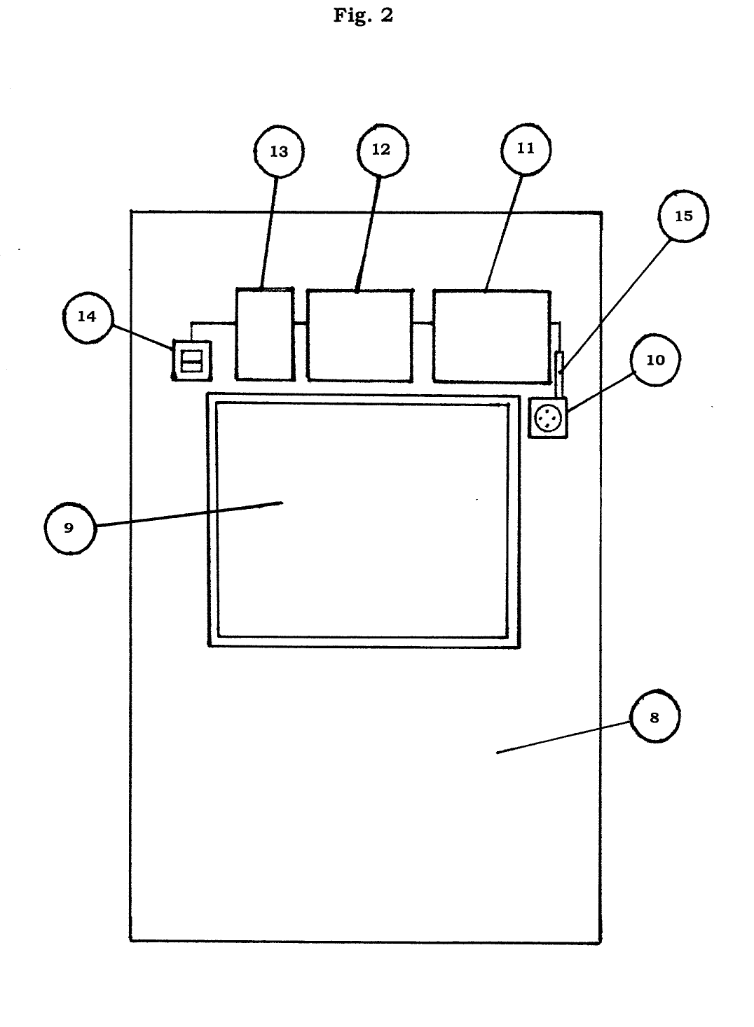

FIG. 2 illustrates the the inside of welding hood depicted in FIG. 1. The welding hood lens 9 is shown mounted onto the welding hood 8. The power switch 14 activates the electronic components mentioned below. The battery housing 13 holds batteries that provide the power supply for the electronic components. The shutter control 12 causes said welding lens to achieve specific shading from among a plurality of shades. The microphone 10 is the voice activation input device. The voice activation control 11 is the device which converts the welder's voice commands into electronic signals which operate said shutter control. The radio frequency shielding device 15 protects the electronic components from being mis-activated by the R.F. associated with arc welding.

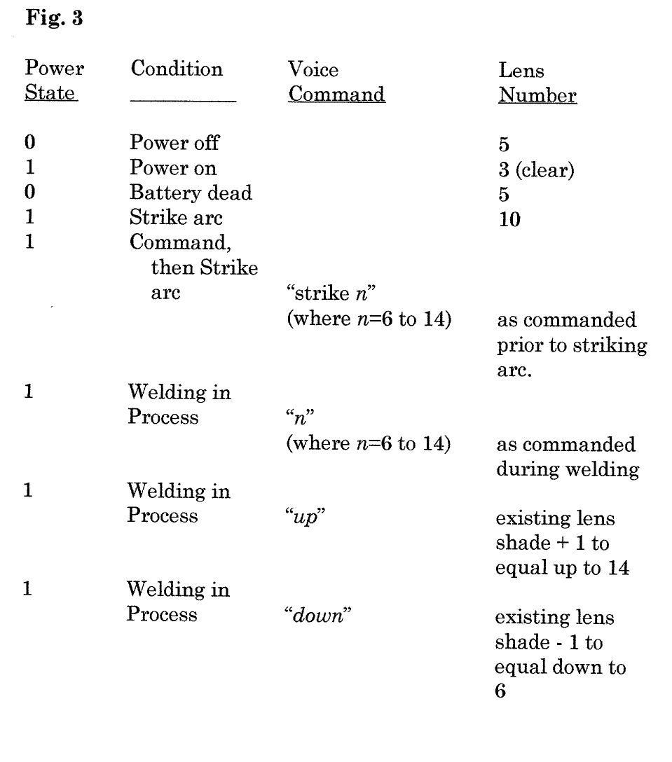

FIG. 3 shows a chart of the preferred embodiment of voice-activation command set.

### DETAILED DESCRIPTION

This invention would be useful in any welding application, but especially that which requires welder to work where ambient light is inconsistent, or wherever welder could have difficulty seeing the weld due to changes in light and shadow. Welders who must work outside, or who must weld around pipe or tanks would find the invention particularly useful. Additionally, the invention would provide production welders the ability to weld, cut, or grind without ever requiring welder to lift hood to at-rest position 7.

The preferred embodiment of the welding hood 1 would consist of a physical shape which would provide protection from sparks and slag, protection from light leaks and reflections, and adequate ventilation. The welding hood may be constructed of a non-conductive, non-combustible, light weight material. Fibrous or plastic materials currently used in construction of welding hoods are preferred. The welding hood harness 2 secures the hood to the welder's head via a size adjustment knob 4. The harness is equipped with a hinge mechanism 5 which allows the hood to be worn in the welding position 6 or in the at-rest position 7. The welding hood lens 3 is of a size typically used by manufacturers of electronic welding hoods. The lens consists of a liquid crystal shutter device whose shade can be adjusted electronically.

The components found inside of the welding hood are arranged to achieve optimal visibility through the lens, to have easy access to batteries, to minimize contact with perspiration, and to minimize exposure of electrical circuitry to interference by radio frequencies. The welding lens 9 is typical of those which use liquid crystal shutters to achieve a plurality of effective welding lens shades. Companies such as Speedglas use such lenses in their variable lens welding hoods. The lens shutter control device 12 provides low voltage signals to the welding lens, enabling the lens shutter to reach the desired degree of shading. The voice activation control 11 consists of an integrated circuit, such as Sensory, Inc's Voice Direct 364.

Automatic/default settings of the welding hood lens would be as follows:

Welder would power on the lens by power switch 14, and it would go to a clear state, shade 3. If welder strikes an arc, the lens would automatically attain shade 10. This is typical of welding lenses described in the prior art. The welding hood's lens would default to shade 5 with power off or if the battery fails.

Voice-command settings of the welding hood lens would be as follows: Upon powering on the welding hood and placing it in the welding position, welder may say, “strike n,” (with n representing any number between 6 and 14). At this command, the voice-activation unit would cause the lens to darken to the nth shade, overriding the automatic default to 10 upon striking of arc. While welding, as lighting conditions change, welder may say “n,” causing the lens shutter to change to the nth shade. If the welder wanted to increase or decrease the shade by increments of 1, he could say, “up,” or “down,” and the lens shutter would make requested adjustment.

The description provided above is merely an example of how the welding hood command set might be used by a skilled welder under field conditions. It is not intended to be the only possible embodiment of the invention. The claims themselves describe the scope of the invention.

What is claimed is:

1. An apparatus which allows human voice control of degree of shading of lenses used for welding, comprising:
a microphone for receiving commands generated by human voice;
a signal processor which converts said voice commands into an electrical signal;
a speech recognition engine which tests whether said electrical signal correspond with one of a plurality of pre-designated commands;
a welding lens shutter control device, which responds to the receipt of one of the said pre-designated commands by adjusting said welding lens shutter to one of a plurality of settings.
a portable power supply which provides electrical power to the said apparatus.

2. A method for human voice control of degree of shading of lenses used for welding, comprising:
a human voice command;
said voice command translated to electrical signal;
said electrical signal causing welding lens shutter to achieve setting requested by said voice command.
